(19) United States
(12) Patent Application Publication
(10) Pub. No.: US 2018/0153198 A1
(43) Pub. Date: Jun. 7, 2018

(54) METHOD FOR PRODUCING ROASTED NORI

(71) Applicant: KOASA CORPORATION, Nagoya-shi, Aichi (JP)

(72) Inventors: Satoru SHIRAHA, Fukuoka (JP); Nobuyasu KANO, Aichi (JP); Shin-ichiro MIWA, Fukuoka (JP)

(73) Assignee: KOASA CORPORATION, Nagoya-shi, Aichi (JP)

(21) Appl. No.: 15/579,825

(22) PCT Filed: Jul. 8, 2016
(86) PCT No.: PCT/JP2016/070306

§ 371 Date: Dec. 5, 2017

(30) Foreign Application Priority Data
Nov. 4, 2015 (JP) 2015-216443

(51) Int. Cl. A23L 17/60; A23L 3/005; A23L 5/10; A23L 3/18; A47J 27/04

(52) U.S. Cl. CPC A23L 17/60; A23L 3/005; A23L 5/15; A47J 2027/043; A47J 27/04; A23V 2002/00; A23L 3/185

(57) ABSTRACT

Provided is a method for producing roasted nori, comprising a heating treatment step in which immobilized sheet-like nori is treated with superheated steam for at least one second. The present invention also relates to a heating treatment machine for heat-treating sheet-like nori, which includes: a nori placement section that has an upper surface on which nori is placed, and a lower surface located at the side opposite to the upper surface; an uplift prevention section which has a lower surface disposed so as to face the upper surface of the nori placement section, and which is configured to be situated so as to leave a space of at most 50 mm between the upper surface of the nori placement section and the lower surface of the uplift prevention section; a superheated steam blast port for blasting superheated steam over the nori placed on the nori placement section; and a superheated steam generation device for generating superheated steam and supplying the superheated steam to the superheated steam blast port.

### TECHNICAL FIELD

The present invention relates to a method for producing roasted nori, and a heat treatment apparatus for roasting nori which is used in the method.

### BACKGROUND ART

Sheeted nori is produced by washing and mincing nori algae cultivated in local sea areas, further washing the minced nori with fresh water, draining it off through a nori-making screen, and drying the nori to a water content of about 6% to 10%. Roasted nori is produced by roasting sheets of drained and dried nori.

For example, Patent Literature 1 describes a nori roasting method including a step of roasting a dried nori feedstock while continuously passing the dried nori feedstock through a far infrared heating apparatus by means of a transfer device. In this step, the heating temperature and the transfer speed of the transfer device are controlled so that the surface of the roasted nori has a prescribed color tone after the roasting.

Further, Patent Literature 2 describes a seaweed roast-processing method using superheated steam, characterized by roasting seaweed while moving the seaweed in an atmosphere in which superheated steam is forced to flow.

Non Patent Literature 1 describes that superheated steam is practically used in widespread applications such as steam ovens. Further, Non Patent Literature 1 describes that the sensible heat of superheated steam is 0.48 kcal/kg/° C., which is approximately twice that of air being 0.28 kcal/kg/° C., and therefore the heating efficiency is very high and the transfer of thermal energy is uniform and quick.

### PRIOR ART DOCUMENTS

### Patent Literature

Patent Literature 1: Japanese Patent Publication No. H05-74340
Patent Literature 2: Japanese Patent Application Kokai Publication No. 2007-312768

### Non Patent Literature

Non Patent Literature 1: Development of Healthy Cooking Technology with Superheated Steam; SHARP CORPORATION Technical Journal, 2005

### DISCLOSURE OF THE INVENTION

### Problems to be Solved by the Invention

Roasted nori is made by roasting sheets of drained and dried nori. If roasting takes place at a water content of 3% or above, phenomena such as wrinkles and shrinkage are generated to markedly deteriorate the commercial value. For this reason, sheeted nori is usually subjected, before roasting, to flame drying in which the water content is reduced to not more than 3% while changing the drying temperature stepwise, and is thereafter roasted at 200° C. to 350° C. while checking the doneness. A common roasting technique uses infrared rays or far infrared rays as the heat source. With such a technique, the application of thermal energy to the nori surface is mainly linear. Because the distance from the heat source differs slightly from place to place on the nori surface due to irregularities, some regions are over roasted and are shrunk or wrinkled or become charred. The doneness of roasting is sometimes adjusted to meet the consumer preference.

Some requirements for roasted nori are that the color tone and umami ingredients are intact, that the nori is free from a phenomenon so-called “color reversion”, that the nori has good “crispness”, and that the count of general viable bacteria present in roasted nori is small. Chlorophyll and amino acids that are contained in nori are caused to disappear by over roasting, which leads to a loss of color tone or a loss of umami ingredients. The “color reversion” is a phenomenon in which the characteristic bright green color of roasted nori changes to red brown or dark brown due to a denaturation of the residual pigments ascribed to insufficient heating of sheeted nori. The quality of “crispness” is related to the softness of nori, and is affected not only by the quality of nori feedstock but also by the denaturation of nori surface tissues by heating. While the general viable count is sometimes about 10⁷ per 1 g of sheeted nori before roasting, it is necessary that the count of general viable bacteria present in roasted nori, particularly, in roasted nori that will be handled outside Japan, have been reduced to 10³ or less per 1 g.

To ensure the above-described quality required of roasted nori, uniform and sufficient heating in the step of roasting sheeted nori is an important factor.

As described above, there are various requests on the quality of roasted nori. In particular, controlling of the general viable count is critical in order to extend the expiration period. Unfortunately, a current roasting method such as far infrared roasting reduces the bacterial count only to about 1/100, and a problem is encountered where roasted nori that is produced contains a large number of general viable bacteria on the order of 10⁵ or more per 1 g. Further, because sheeted nori is a stack of layers of nori that have been cut, linear heating such as far infrared heating cannot transfer thermal energy to the inside sufficiently and uniformly, with the result that the quality of roasted nori in terms of, for example, color reversion and crispness is adversely affected. To avoid this, nori needs to be heated sufficiently and uniformly. The method described in Patent Literature 2 is such that water is sprayed to a burner to form steam, and superheated steam is forced to circulate. This manner of roasting is problematic in that heating is nonuniform and fails to roast nori stably, resulting in color reversion, poor crispness, and variations in bactericidal effects and in the survival of ingredients. Thus, there has been a demand for a roasted nori production method which eliminates the “color reversion” phenomenon uniformly while suppressing the occurrence of shrinkage, waves and chars by heating, and which ensures a certain level of “crispness” and can kill bacteria to a sufficient degree.

Objects of the present invention are to provide a roasted nori production method which can sterilize roasted nori sufficiently, and to provide a heat treatment apparatus for roasting nori which is used in the method. Further, the present invention has objects of providing a roasted nori production method which can produce roasted nori having a certain level of “crispness” while reducing the loss of chlorophyll and amino acids by heating and eliminating the occurrence of “color reversion” phenomenon, and providing a heat treatment apparatus for roasting nori which is used in the method.

### Means for Solving the Problems

The sensible heat of superheated steam is 0.48 kcal/kg/° C., which is approximately twice that of air being 0.28 kcal/kg/° C., and therefore the heating efficiency is very high and the transfer of thermal energy is uniform and quick. However, because of being water, steam can cause a decrease in the quality of nori by generating winkles, shrinkage or the like. The present inventors, in light of the above problems, performed extensive studies in which nori was roasted while changing the mechanisms of roasting with superheated steam, the roasting temperature, the amount of superheated steam and the treatment time. As a result, the present inventors have identified the conditions which allow roasted nori to be produced while solving the aforementioned problems. Further, the present inventors have developed a heat treatment apparatus for the roasting of nori based on the conditions identified for the production of roasted nori.

An aspect of the present invention resides in a method for producing roasted nori including a heat treatment step of treating sheeted nori fixed so as not to separate from a nori placement section, with superheated steam for 1 second or more.

This aspect makes it possible to provide sterilized roasted nori by virtue of the heat treatment being effected sufficiently over the entire surface of sheeted nori under constant roasting conditions no matter the quality of the sheeted nori. Further, the above aspect ensures that phycobilin pigments disappear sufficiently while the loss of chlorophyll pigments and umami-provider free amino acids is small, and thereby makes it possible to provide roasted nori that does not undergo the “color reversion” phenomenon. At the same time, it becomes possible to provide roasted nori having a certain level of “crispness”.

In another aspect, the method for producing roasted nori according to the invention includes a preliminary heating step of heating nori in a form of sheet at a temperature of not less than 50° C. with a preliminary heating device, and a heat treatment step of fixing the nori subjected to the preliminary heat treatment so as not to separate from a nori placement section, and treating the nori with superheated steam for 1 second or more.

According to this aspect, nori is heat treated sufficiently over its entire surface, and the superheated steam can be prevented from being condensed on the nori surface when the steam is brought into contact with the nori. Thus, it becomes possible to provide roasted nori having little wrinkles or shrinkage.

In another aspect of the method of the invention, the temperature of the superheated steam in the heat treatment step is in the range of 150 to 500° C.

This aspect ensures that sheeted nori is sufficiently heat treated, and thereby makes it possible to provide roasted nori having a reduced general viable count.

In another aspect of the method of the invention, the time of the heat treatment with the superheated steam is between 1 second and 90 seconds.

This aspect ensures that sheeted nori is heat treated sufficiently without suffering a loss of chlorophyll and umami ingredients present in the sheeted nori, and thereby makes it possible to provide roasted nori which maintains high quality.

In another aspect of the method of the invention, the amount of the superheated steam sprayed during the heat treatment step is not less than 10 kg/h.

This aspect ensures that the superheated steam can superheat sheeted nori sufficiently without nonuniformity, and thereby makes it possible to provide roasted nori having a reduced general viable count.

In another aspect of the method of the invention, the count of viable bacteria present in the nori after the step of treating the nori with the superheated steam is not more than 10⁵ per 1 g.

This aspect makes it possible to provide roasted nori which allows a food using the roasted nori to remain good for an extended expiration period.

A further aspect of the present invention resides in a heat treatment apparatus for heat treating sheeted nori, including a nori placement section having an upper face to place nori thereon and a lower face opposite to the upper face, an uplift preventing section arranged so that a lower face thereof is opposed to the upper face of the nori placement section with a maximum distance between the upper face of the nori placement section and the lower face of the uplift preventing section being 50 mm, a superheated steam jet orifice through which superheated steam is sprayed to the nori placed on the nori placement section, and a superheated steam generator which generates superheated steam and supplies the superheated steam to the superheated steam jet orifice.

This aspect makes it possible to sufficiently sterilize sheeted nori under constant roasting conditions no matter the quality of the sheeted nori. Further, this aspect ensures that phycobilin pigments disappear sufficiently while the loss of chlorophyll pigments and umami-provider free amino acids is small, and thereby makes it possible to provide roasted nori that does not undergo the “color reversion” phenomenon. At the same time, it becomes possible to provide roasted nori having a certain level of “crispness”.

In another aspect of the heat treatment apparatus of the invention, the superheated steam jet orifice is arranged so as to be capable of spraying the superheated steam to an upper face of the uplift preventing section, and the uplift preventing section is configured to allow the superheated steam to pass therethrough from the upper face to the lower face thereof.

This aspect allows the superheated steam to be distributed over the entire surface of nori, and thereby makes it possible to effect the heat treatment more uniformly and sufficiently.

In another aspect of the heat treatment apparatus of the invention, the superheated steam jet orifice is arranged so as to be capable of spraying the superheated steam to the lower face of the nori placement section, and the nori placement section is configured to allow the superheated steam to pass therethrough from the lower face to the upper face thereof.

This aspect allows the superheated steam to be distributed over the entire surface of nori, and thereby makes it possible to effect the heat treatment more uniformly and sufficiently.

In another aspect of the heat treatment apparatus of the invention, the nori placement section is a belt conveyer including a mesh belt or a plurality of parallel filamentary belts.

This aspect allows the superheated steam to be distributed over the entire surface of nori, and thereby makes it possible to effect the heat treatment more uniformly and sufficiently. Further, the heat treatment can be automated on a moving line, and it becomes possible to perform the heat treatment of sheeted nori efficiently.

In another aspect, the heat treatment apparatus of the invention further includes a device that performs preliminary heating of nori.

According to this aspect, the superheated steam can be prevented from being condensed on the nori surface when the steam is brought into contact with the nori. Thus, it becomes possible to produce roasted nori having little wrinkles or shrinkage.

### Effects of the Invention

The present invention can provide a roasted nori production method which can sterilize roasted nori sufficiently, and a heat treatment apparatus for roasting nori which is used in the method. Further, the present invention can provide a roasted nori production method which can produce roasted nori having a certain level of “crispness” while reducing the loss of chlorophyll and amino acids by heating and eliminating the occurrence of “color reversion” phenomenon, and a heat treatment apparatus which is used in the method.

### BRIEF DESCRIPTION OF DRAWING

FIG. 1 is a sectional schematic view illustrating an example of heat treatment apparatuses associated with a method of the invention.

### DESCRIPTION OF EMBODIMENTS

«Roasted Nori Production Method»

The present invention is concerned with a method for producing roasted nori including a heat treatment step of treating sheeted nori fixed so as not to separate from a nori placement section, with superheated steam for 1 second or more. The method of the invention will be described in detail hereinbelow.

[Superheated Steam]

Superheated steam refers to steam having a temperature of not less than the saturation temperature at a given pressure. In the present specification, unless otherwise mentioned, this term means steam that has been heated to above 100° C. under atmospheric pressure. The superheated steam is steam heated to a temperature higher than 100° C. Superheated steam has a sensible heat approximately two times greater than that of air, and therefore the heating efficiency is very high and the thermal energy is transferred uniformly and quickly. For this reason, superheated steam is used as a heating medium. In the method of the invention, superheated steam is sprayed to sheeted nori that has been fixed, and thereby roasts and sterilizes the sheeted non. The superheated steam may be generated by any known method without limitation. For example, a method may be adopted in which water is vaporized by being sprayed to a burner, and the steam is further heated with a heater to attain an increased temperature. The superheated steam is sprayed from a jet orifice to sheeted nori. The superheated steam may be sprayed to one side of the sheeted nori, or may be sprayed to both sides of the sheeted nori. Because the heating and sterilization efficiencies are further enhanced, it is preferable that the superheated steam be sprayed to both sides of the sheeted nori. An example approach to heating both sides of sheeted nori is to use a mesh as a portion on which the sheeted nori is placed.

[Treatment Temperature]

Of the 4 kinds of pigments (chlorophyll, carotene, phycocyanin and phycoerythrin) present in nori, phycocyanin and phycoerythrin which are so-called phycobilin pigments are thermally denatured and disappear during heating of nori. Consequently, chlorophyll and carotene remain and show a bright green color on roasted nori. If the thermal energy is not transferred to the inside sufficiently and the phycobilin pigments are allowed to remain, the residual phycobilin pigments are denatured by water or pH when, for example, the roasted nori is brought into contact with other food. This denaturation can cause a phenomenon so-called “color reversion” in which the characteristic bright green color of roasted nori changes to red brown or dark brown, with the result that the commercial value is significantly deteriorated. If nori is strongly roasted to promote the disappearance of phycobilin pigments and thereby to prevent color reversion, more chlorophyll and amino acids are also caused to disappear to give rise to a change in color, a loss of umami ingredients and in some cases the generation of “burnt smell”, possibly deteriorating the commercial value. In light of these facts, the temperature of the heat treatment with the superheated steam is preferably 150° C. to 500° C., more preferably 150° C. to 400° C., still more preferably 150° C. to 300° C., and particularly preferably 200° C. to 280° C. By controlling the heat treatment temperature to fall in this range, phycobilin pigments are caused to disappear and high-quality roasted nori can be provided while avoiding a significant decrease in the amounts of chlorophyll and amino acids. Further, the above temperature ensures that general viable bacteria present in the roasted nori can be reduced to a very small number by heating.

[Treatment Time]

The time of the heat treatment of sheeted nori is, although variable depending on the heat treatment temperature, 1 second to 90 seconds, preferably 1 second to 20 seconds, and still more preferably 3 seconds to 20 seconds. When the heat treatment time is in this range, sheeted nori is sufficiently heated and gives roasted nori having a very small general viable count. The heat treatment time may be controlled with a known device such as a timer. A mechanism may be adopted in which the nozzle of the superheated steam jet orifice is closed after the lapse of a prescribed time. When, for example, the nori placement section is a belt conveyer type, the heat treatment time may be controlled by conditions such as the speed of the belt conveyer, the size of the heating furnace, and the travel distance in the heating furnace. By designing, for example, the effective length of the heating section in the heating furnace to 2000 mm and the belt conveyer speed to 22 m/min, the heat treatment time may be controlled to approximately 6 seconds.

[Amount of Superheated Steam]

The amount of the superheated steam sprayed from a superheated steam jet orifice is preferably 10 kg/h to 90 kg/h, and more preferably 20 kg/h to 70 kg/h. For reasons such as technical difficulties in measuring the steam pressure at a site of spraying to nori, it is difficult to specify the amount of superheated steam actually sprayed to the nori. After extensive studies, however, the present inventors have found that sufficient and uniform heating of sheeted nori is achieved when the amount of the superheated steam supplied to a superheated steam jet orifice is in the above range. By setting the amount of the superheated steam to the above range, the density of the superheated steam in the roasting device can be maintained and heating of sheeted nori can be effected sufficiently and uniformly. The temperature of the superheated steam, the time of the heat treatment, and the amount of the superheated steam may be changed or set appropriately in accordance with the design of the heat treatment apparatus such as the size of the roasting device and the amount of sheeted nori which can be treated at a time.

[Fixation of Sheeted Nori]

In the method of the invention, sheeted nori is fixed prior to heating of the sheeted nori with superheated steam in order to prevent its displacement from the heating position by factors such as lifting of the sheeted nori by the superheated steam. Here, the phrase that the sheeted nori is “fixed” means that the positional relationship of the sheeted nori relative to the position where the sheeted nori is placed is not substantially changed during heating, in particular, the sheeted nori is not lifted or separated away from the placement section. Any displacement such as lifting of the sheeted nori during the heat treatment step deteriorates the uniformity of heating and results in insufficient sterilization. The method for fixing the sheeted nori is not limited as long as the fixation does not inhibit the superheated steam from being sprayed to the entire surface of the sheeted nori. For example, the heat treatment apparatus may be fitted with a mechanism which prevents lifting of the sheeted nori by sandwiching the sheeted nori between the mechanism and the nori placement section. Examples of such mechanisms include a mesh wall member disposed in the vicinity of the upper face of the nori placement section.

[Preliminary Heating]

The method of the invention may include a preliminary heating step of heating nori that has been processed into a form of sheet, at a temperature of not less than 50° C. with a preliminary heating device, prior to the heat treatment step using the superheated steam. The preliminary heating step is performed to raise the product temperature of the sheeted nori that will be heat treated and thereby to prevent the condensation of the superheated steam on the nori surface. The preliminary heating step makes it possible to prevent the generation of defects such as wrinkles by the condensation of the superheated steam. The preliminary heating step is preferably performed at 50° C. or above, more preferably 70° C. or above, and still more preferably 100° C. or above. To ensure that the nori is not over roasted and dose not reduce its flavor, the temperature in the heating step is 200° C. or less, preferably 150° C. or less, and more preferably 130° C. or less. The heat treatment in the preliminary heating step is performed until the sheeted nori is warmed to a sufficient extent. The time of the preliminary heat treatment is, although variable depending on the heating temperature, 1 second or more, preferably 5 seconds or more, and more preferably 15 seconds or more. The sheeted nori that has undergone the preliminary heating step is subjected to the superheated steam treatment in the roasting device before its product temperature falls.

«Heat Treatment Apparatus for Sheeted Nori»

Hereinbelow, an example apparatus for the heat treatment of sheeted nori which represents a specific embodiment for carrying out the method of the present invention will be described in detail with reference to the drawing.

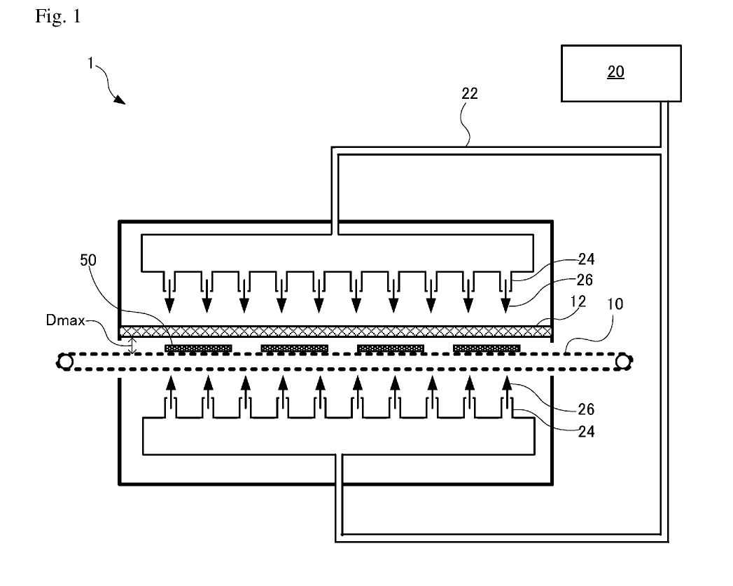

The heat treatment apparatus of the present invention is a heat treatment apparatus for heat treating sheeted nori which includes a roasting device and a superheated steam supply device, and is configured so that the roasting temperature, the amount of superheated steam and the treatment time can be controlled. FIG. 1 illustrates a sectional schematic view of an example of the heat treatment apparatuses of the invention.

<Roasting Device>

The roasting device is a device which roasts nori using an action of superheated steam. This device includes a nori placement section 10, a nori uplift preventing section 12, and a heating furnace. The superheated steam used in the heat treatment apparatus of the invention is, as already mentioned, steam that has been heated to above 100° C. under atmospheric pressure.

[Nori Placement Section]

The nori placement section 10 has an upper face to place nori thereon and a lower face opposite to the upper face. Sheeted nori to be subjected to the heat treatment is placed on the upper face of the nori placement section 10. Because sheeted nori is usually handled with a size of 19 cm×21 cm, it is preferable that the nori placement section 10 have a face larger than this size. The upper face of the nori placement section 10 may have any of various shapes including not only rectangles but also circles and rings as long as the upper face allows sheeted nori to be placed thereon.

To distribute the superheated steam over the entire surface of sheeted nori more efficiently, the nori placement section 10 is preferably configured to allow a gas, in particular, steam to pass therethrough from its lower face to upper face. To attain this configuration, the nori placement section 10 is preferably perforated and is more preferably a mesh. The intervals or size of the holes or openings is not particularly limited as long as the superheated steam can sufficiently pass therethrough and the sheeted nori does not fall from the nori placement section 10. There is preferably a gap below the lower face of the nori placement section 10 to accommodate a superheated steam jet orifice 24 described later. The size of the holes or openings may be, for example, 0.0015 to 100 cm², and preferably 0.15 to 25 cm².

The structure of the nori placement section 10 is more preferably a transfer device such as a belt conveyer because the superheated steam can be sprayed to the entire surface of the sheeted nori evenly and the heat treatment step can be performed efficiently. Particularly preferably, the structure is a belt conveyer including a mesh belt or a plurality of parallel filamentary belts. Here, the term “filamentary belts” means belts having a small belt width. Round belts or the like may be used as the filamentary belts. The sectional shape of the filamentary belts may be a circle as in round belts, or may be any of other shapes such as rectangles and V-shapes. The intervals between adjacent belts of the plurality of filamentary belts is not limited as long as sheeted nori can be placed stably. The nori placement section 10 may have other structure such as a ladder chain.

[Uplift Preventing Section]

The uplift preventing section 12 is a mechanism that prevents the sheeted nori from being displaced from the heating position by, for example, being lifted by the superheated steam. The uplift preventing section 12 is arranged so that its lower face is opposed to the upper face of the nori placement section. The maximum distance between the upper face of the nori placement section 10 and the lower face of the uplift preventing section 12 is 50 mm. The maximum distance is preferably 30 mm, and more preferably 10 mm. As long as the maximum distance is in the above range and the lifting of the nori can be prevented, the lower face of the uplift preventing section 12 may have irregularities. Further, as long as the superheated steam can be sprayed to the sheeted nori, the uplift preventing section 12 may be arranged so as to press the sheeted nori between itself and the nori placement section 10. The upper face of the nori placement section 10 and the lower face of the uplift preventing section 12 are to satisfy the above distance at least during the time when sheeted nori is heat treated. The uplift preventing section 12 may be designed so that its lower face is movable in, for example, a vertical direction to facilitate a placement of sheeted nori onto the nori placement section 10.

The size of the uplift preventing section 12 is not particularly limited as long as the uplift preventing section substantially covers sheeted nori and can prevent lifting of the sheeted nori. The size is preferably larger than the sheeted nori to be heat treated, and is more preferably such that the nori placement section 10 is substantially covered.

To distribute the superheated steam over the entire surface of sheeted nori more efficiently, the uplift preventing section 12 is preferably configured to allow a gas, in particular, steam to pass therethrough from its upper face to lower face. To attain this configuration, the uplift preventing section 12 is preferably perforated and is more preferably a mesh. The intervals or size of the holes or openings is not particularly limited as long as the superheated steam can sufficiently pass therethrough and the sheeted nori can be prevented from being lifted. There is preferably a gap above the upper face of the uplift preventing section 12 to accommodate a superheated steam jet orifice 24 described later. Preferred design embodiments such as the size of the holes or openings may be the same as those in the nori placement section 10.

The structure of the uplift preventing section 12 may be a belt conveyer in order to transfer the sheeted nori in an fixed state and to attain more efficient heat treatment. The mechanism of the belt conveyer may be the same as that in the nori placement section 10.

[Heating Furnace]

The roasting device has a heating furnace that is a space in which sheeted nori is treated with superheated steam. The size of the heating furnace is not particularly limited as long as the heating furnace accommodates at least part of the nori placement section 10 and at least part of the uplift preventing section 12. The heating furnace is preferably fitted with a thermal insulation mechanism such as partitions which prevents a leakage of thermal energy to the outside and thereby increases the thermal efficiency in the heat treatment and prevents a temperature drop and the consequent condensation of the superheated steam. The inlet port for the introduction of sheeted nori and the outlet port for the collection of roasted nori can be a cause of a temperature drop by allowing an entry of outside air. Thus, the sheeted nori introduction port and the roasted nori collection port may be designed so that they can be thermally insulated by doors, or the inlet and outlet of the belt conveyer may be designed narrow to reduce the regions through which heat can flow in and out. The furnace is preferably equipped with one or more temperature sensors so that the temperature inside the heating furnace can be monitored.

As known in the art, roasting with superheated steam can be performed in a low oxygen atmosphere, and the loss of components by oxidation encountered in usual heating can be reduced, with the result that pigments such as chlorophyll and (3-carotene, and umami-provider amino acids remain at a higher ratio than in usual roasting. Although the gas supplied to the heating furnace can contain compressed air used to forcefully feed the superheated steam, the treatment can take place in a low oxygen atmosphere because the superheated steam represents the major proportion of the volume. In addition, to attain a further reduced oxygen content, the heating furnace may be fitted with a mechanism that purges the inside of the device with an inert gas such as nitrogen so that the treatment can take place in a low oxygen atmosphere.

The heating furnace is connected to a superheated steam exhaust port, and the superheated steam used for the heat treatment of sheeted nori is discharged outside the roasting device through the exhaust port. The steam discharged can be recycled by being recovered, distilled and introduced to a superheated steam generator 20 described later. Such a steam recycle mechanism can realize efficient use of water and a reduction of costs.

<Superheated Steam Supply Device>

The superheated steam supply device is a device that supplies superheated steam to the roasting device. The superheated steam generated by the superheated steam generator 20 disposed in the superheated steam supply device is supplied to a superheated steam jet orifice 24 through a superheated steam transfer section.

[Superheated Steam Generator]

The superheated steam generator 20 is a device that generates superheated steam. The superheated steam generator 20 includes a saturated steam generator and a heating device. The saturated steam generator is a device that heats water to form saturated steam. The saturated steam generator is not particularly limited and may be, for example, a general boiler using liquefied propane gas. The water used to generate saturated steam does not need to be high-purity water such as purified water, but is preferably free from impurities which form residues after vaporization, and components having a lower boiling point than water. The water used to generate saturated steam may be tap water, pure water or the like, and is preferably tap water from the point of view of cost. The steam used for the heat treatment is preferably recovered and reused as distilled water. In this manner, efficient use of water can be made and the cost can be reduced. The feed rate of water is preferably not less than 15 kg/h, and more preferably not less than 100 kg/h in order to ensure a sufficient amount of superheated steam sprayed to sheeted nori. Further, the superheated steam generating section 20 may be fitted with a mechanism that supplies air in order to transfer smoothly the superheated steam through a superheated steam transfer section. The feed rate of air is preferably 10 to 1500 L/min, and more preferably 100 to 1200 L/min in order to transfer the steam with good efficiency.

The heating device is used as a heat source that produces superheated steam by heating the saturated steam from the saturated steam generator to a prescribed temperature. The heat source of the heating device is not particularly limited, and any heat source capable of heating a gas such as an electromagnetic induction type or a direct heating type may be used. The heating device is not particularly limited as long as the heat source can heat steam to 100° C. or above. A preferred heat source is one having a heating performance of up to a maximum of 1500° C. in terms of the heating element temperature. A heat source capable of heating to 600° C. is more preferable. By heating of steam with the heating device, the temperature of the steam can be preferably increased to 150° C. to 800° C., more preferably 150 to 500° C., and still more preferably 200° C. to 400° C. The amount of superheated steam generated by the saturated steam generator may be preferably 10 kg/h to 200 kg/h, and more preferably 10 kg/h to 120 kg/h in order to supply a sufficient amount of superheated steam to the roasting device.

[Superheated Steam Transfer Section]

The superheated steam generated by the superheated steam generator 20 is guided through a superheated steam transfer section such as a superheated steam transfer pipe 22 to a superheated steam jet orifice 24 connected to the roasting device. The type of a material used in the superheated steam transfer section is not particularly limited as long as the material can withstand the pressure of the superheated steam. A material having high thermal insulation properties is preferably used to avoid a decrease in temperature of the superheated steam. The exterior of the superheated steam transfer section may be covered with a vacuum space to keep the temperature of the superheated steam. The heating device provided in the superheated steam generator 20 may be disposed inside the superheated steam transfer section.

[Superheated Steam Jet Orifice]

The superheated steam jet orifice 24 is a mechanism through which the superheated steam guided from the superheated steam transfer section is jetted into the roasting device. For example, the superheated steam transfer pipe 22 may be perforated and the hole may be used as the superheated steam jet orifice 24. A nozzle may be attached to the superheated steam transfer section. The use of a convergent nozzle increases the pressure of the superheated steam and thus makes it easy for the superheated steam to effect heating to the inside of the sheeted nori. The use of a divergent nozzle facilitates the diffusion of the superheated steam and allows the superheated steam to be easily distributed over the entire surface of the sheeted nori.

As long as the superheated steam can be sprayed to the sheeted nori, the superheated steam jet orifice 24 may be arranged at any position inside the roasting device, and may be directed to the upper face, lower face or lateral side of the sheeted nori placed on the nori placement section 10. Because the superheated steam is jetted with an enhanced efficiency, the jet orifice is preferably arranged so as to be capable of spraying the steam to the sheeted nori from its upper face or lower face. When, for example, the nori placement section 10 is a mesh, the superheated steam jet orifice 24 may be arranged so as to be capable of spraying the superheated steam to the lower face of the nori placement section 10 so that the superheated steam can pass through the nori placement section 10 from its lower face to upper face. When the uplift preventing section 12 is a mesh, the superheated steam jet orifice 24 may be arranged so as to be capable of spraying the superheated steam to the upper face of the uplift preventing section 12 so that the superheated steam can pass through the uplift preventing section 12 from its upper face to lower face.

At least one superheated steam jet orifice 24 needs to be disposed in the roasting device. To perform efficient heat treatment, a plurality of such orifices are preferably disposed. It is also preferable that the superheated steam jet orifices 24 be located at intervals that allow the sheeted nori to be heat treated evenly. The number and intervals of the superheated steam jet orifices 24 may be designed appropriately based on factors such as the reach of the spray of superheated steam determined by the structure of the superheated steam jet orifice 24 and by the pressure of the superheated steam, and the size of the sheeted nori.

The superheated steam jet orifice 24 may be a nozzle-like orifice having a sectional area of 0.007 to 60 cm², or preferably a sectional area of 0.03 to 30 cm². When there are two or more superheated steam jet orifices 24, they may be arranged inside the heating furnace so that the intervals in the longitudinal direction and in the transverse direction are each, for example, 0.5 to 100 cm, or preferably 5 to 20 cm. The temperature of the superheated steam jetted from the superheated steam jet orifice 24 is preferably 150° C. to 800° C., more preferably 150 to 500° C., and still more preferably 200° C. to 400° C.

If the treatment of sheeted nori with superheated steam takes place while the product temperature of the sheeted nori is ambient, the superheated steam is condensed at the instant when the steam is brought into contact with the surface of the sheeted nori due to the difference in temperature between the nori and the superheated steam. This tends to result in the generation of shrinkage or wrinkles. In light of this fact, the heat treatment apparatus of the present invention may include a device that preliminarily heats the nori for the purposes of raising the temperature of the nori before the treatment and preventing the condensation of steam. The preliminary heating device may be a known heat source such as an infrared or far infrared heater, or an electrically heated wire. Preferably, the preliminary heating device and the roasting device are connected to each other or are combined in one unit to avoid a decrease in the product temperature of the sheeted nori that has been preheated. The design may be such that a belt conveyer passes through the preliminary heating device and the roasting device sequentially. Alternatively, the heat source of the preliminary heating device may be installed inside the roasting device and a mechanism may be provided which allows the operation to be switched between the spraying of the superheated steam and the preliminary heating.

The specific shape of the heat treatment apparatus is not limited as long as the apparatus has the mechanisms described hereinabove and can achieve the objects of the invention. Such portions as the sheeted nori introduction port and the roasted nori collection port are designed appropriately in accordance with the types and shapes of such members as the nori placement section 10 and the roasting device. A plurality of pairs of the nori placement section 10 and the uplift preventing section 12 may be arranged in the longitudinal or transverse direction inside the heating furnace to allow heat treatment to be performed on a plurality of lines simultaneously.

In the method of heat treating sheeted nori using the above-described heat treatment apparatus, specific operations such as the placement of sheeted nori onto the nori placement section 10, the introduction thereof into the roasting device, and the collection of the roasted nori are carried out appropriately in accordance with the structure of the heat treatment apparatus. When, for example, the nori placement section 10 is a belt conveyer type, the operations are performed as follows. Sheeted nori is placed onto the top position of the belt conveyer that lies out of the heating furnace, the sheeted nori is transferred by the belt conveyer into the heating furnace and is heat treated, and the roasted nori transferred to the end point of the belt conveyer is recovered.

[Roasted Nori]

According to the method of the invention, the count of general viable bacteria present in the nori as measured after the step of treating sheeted nori with superheated steam, is preferably reduced to not more than 10⁵ per 1 g. The general viable count is more preferably not more than 10⁴, and still more preferably not more than 10³ per 1 g.

### EXAMPLES

Next, the present invention will be described in more detail based on Examples, but it should be construed that the present invention is in no way limited to those Examples.

As Comparative Examples, roasted nori was produced by the treatment methods described below. In Comparative Example 1, the treatment involved far infrared rays. In Comparative Examples 2 to 4, the treatment was performed using a roasting machine for simple drying of nori. This roasting machine did not have any nori uplift preventing sections, and was configured to generate superheated steam by direct spraying of water to a burner, with the feed rate of superheated steam being 4 kg/h. In Comparative Examples 5 and 6, roasted nori was produced by treatment without using superheated steam. Separately, roasted nori was produced (Examples 1 to 9) by roasting with superheated steam using a heat treatment apparatus equipped with a nori fixation mechanism according to the method of the invention. The survival ratios of general viable bacteria in the roasted nori obtained by these methods were compared. The heat treatment conditions in Examples and Comparative Examples were as described below. Here, in Examples 5 to 9, roasted nori was produced using a heat treatment apparatus that was a combination of the heat treatment apparatus used in Examples 1 to 4 with a thermal insulation mechanism and an outside air intake prevention mechanism.

### Comparative Example 1

Far infrared roasting: temperature 300° C., treatment time 7.6 sec

### Comparative Example 2

Roasting machine for simple drying: temperature 120° C., superheated steam rate 4 kg/h, treatment time 200 sec

### Comparative Example 3

Roasting machine for simple drying: temperature 150° C., superheated steam rate 4 kg/h, treatment time 100 sec

### Comparative Example 4

Roasting machine for simple drying: temperature 200° C., superheated steam rate 4 kg/h, treatment time 30 sec

### Comparative Example 5

Temperature 260° C., superheated steam rate 0 kg/h, treatment time 15 sec

### Comparative Example 6

Temperature 270° C., superheated steam rate 0 kg/h, treatment time 15 sec

### Example 1

Superheated steam roasting: temperature 280° C., superheated steam rate 70 kg/h, treatment time 6 sec

### Example 2

Superheated steam roasting: temperature 250° C., superheated steam rate 70 kg/h, treatment time 8 sec

### Example 3

Superheated steam roasting: temperature 200° C., superheated steam rate 70 kg/h, treatment time 30 sec

### Example 4

Superheated steam roasting: temperature 180° C., superheated steam rate 70 kg/h, treatment time 45 sec

### Example 5

Superheated steam roasting: temperature 180° C., superheated steam rate 70 kg/h, treatment time 9 sec

### Example 6

Superheated steam roasting: temperature 180° C., superheated steam rate 70 kg/h, treatment time 6 sec

### Example 7

Superheated steam roasting: temperature 200° C., superheated steam rate 10 kg/h, treatment time 30 sec

### Example 8

Superheated steam roasting: temperature 180° C., superheated steam rate 10 kg/h, treatment time 60 sec

### Example 9

Superheated steam roasting: temperature 150° C., superheated steam rate 10 kg/h, treatment time 60 sec

The general viable count was measured with respect to the roasted nori produced under the above conditions and also the sheeted nori before the roasting. The measurement of viable counts was made by a standard agar pour plate method. To prepare test liquids, the roasted nori produced under the above conditions were placed, each 10 g, into respective Stomacher bags, 90 mL of phosphate buffered saline was poured, the mixtures were stomached using STOMACHER 400 DIRCULATOR (manufactured by Seward) at a rotational speed of 230 rpm for 30 seconds, and the resultant bacteria suspensions were used as the bacterial test liquids. A standard agar medium was dispersed in distilled water with an indicated concentration, and was thermally dissolved and sterilized at 120° C. for 20 minutes. The medium was then cooled to about 50° C. and was kept at the temperature. The medium was poured, together with 1 mL of any of the bacterial test liquids, into a sterilized petri dish, and the mixture was stirred sufficiently, allowed to stand and cool to solidification, and kept at 36° C. for 48 hours. The colonies generated were counted. The results are described in Table 1. The general viable count of the sheeted nori before roasting was 1.2×10⁷.

TABLE 1

| | | | | | | Viable |
|---|---|---|---|---|---|---|
| | Treatment | Temperature | Amount of | Amount of | Treatment | count |
| | method | (° C.) | air (L/min) | steam (kg/h) | time (sec) | (cfu/g) |
| | Initial | | | | | 1.2 × 10⁷ |
| Comparative | Far infrared | 300 | — | — | 7.6 | 6.1 × 10⁵ |
| Example 1 | | | | | | |
| Comparative | Superheated | 120 | — | 4 | 200 | 1.0 × 10⁷ |
| Example 2 | steam* | | | | | |
| Comparative | Superheated | 150 | — | 4 | 100 | 6.7 × 10⁶ |
| Example 3 | steam* | | | | | |
| Comparative | Superheated | 200 | — | 4 | 30 | 1.3 × 10⁶ |
| Example 4 | steam* | | | | | |
| Comparative | Air | 260 | 500 | 0 | 15 | 8.4 × 10⁵ |
| Example 5 | | | | | | |
| Comparative | Air | 270 | 500 | 0 | 15 | 6.3 × 10⁴ |
| Example 6 | | | | | | |
| Example 1 | Superheated | 280 | 300 | 70 | 6 | 300 or less |
| | steam | | | | | |
| Example 2 | Superheated | 250 | 500 | 70 | 8 | 300 or less |
| | steam | | | | | |
| Example 3 | Superheated | 200 | 500 | 70 | 30 | 8.4 × 10² |
| | steam | | | | | |
| Example 4 | Superheated | 180 | 500 | 70 | 45 | 1.2 × 10³ |
| | steam | | | | | |
| Example 5** | Superheated | 180 | 500 | 70 | 9 | 300 or less |
| | steam | | | | | |
| Example 6** | Superheated | 180 | 500 | 70 | 6 | 300 or less |
| | steam | | | | | |
| Example 7** | Superheated | 200 | 300 | 10 | 30 | 300 or less |
| | steam | | | | | |
| Example 8** | Superheated | 180 | 300 | 10 | 60 | 300 or less |
| | steam | | | | | |
| Example 9** | Superheated | 150 | 300 | 10 | 60 | 300 or less |
| | steam | | | | | |

*A roasting machine for simple drying was used.
**A heat treatment apparatus equipped with a thermal insulation mechanism and an outside air intake prevention mechanism was used.

From Table 1, the heat treatment apparatus equipped with the nori fixation mechanism according to the method of the invention has been shown to produce roasted nori of very high quality with a significant reduction in general viable count to 10³ or less compared to 1.2×10⁷ before the heat treatment. Examples 5 to 9 have illustrated that sufficient sterilization can be achieved by the inventive method even when the temperature is relatively low, the amount of superheated steam is smaller, or the heating time is shorter. For example, the comparison of Example 7 to Comparative Example 4 shows that in spite of the fact that the heating conditions were substantially the same, Example 7 attained a reduction in general viable count to not more than 300. A significant reduction in general viable count was similarly attained by Example 9 in which the treatment temperature was still lower than in Example 7, as compared to Comparative Example 3. On the other hand, the methods of Comparative Examples 2 to 4 did not complete the roasting of nori itself even by the use of superheated steam, and provided a reduction in general viable count only by about one-tenth of the initial, leaving problems in the quality of the roasted nori.

[Quality Evaluation of Roasted Nori 1]

Roasted nori obtained by roasting with superheated steam, far infrared rays and hot air, and sheeted nori before the roasting were analyzed to measure the phycobilin pigment content, the chlorophyll content, the free amino acid content and the general viable count. Based on the analytical results before and after the roasting, the phycobilin pigment survival ratio, the chlorophyll survival ratio, the umami-provider amino acid survival ratio and the degree of reduction in general viable count were calculated. The degree of reduction in general viable count is shown as the ratio of the count of general viable bacteria present in the sheeted nori before the roasting, to the count of general viable bacteria present in the roasted nori after the roasting. The higher the ratio, the greater the reduction in viable count.

TABLE 2

| | | | Umami- | |
|---|---|---|---|---|
| | Phycobilin | | provider | Degree of |
| | pigment | Chlorophyll | amino acid | reduction |
| | survival | survival | survival | in general |
| | ratio (%) | ratio (%) | ratio (%) | viable count |
| Far infrared | 9.16 | 83.6 | 75 | 10² |
| roasting | | | | |
| Hot air roasting | 9.14 | 81.6 | 87 | 10¹ |
| Superheated | 5.81 | 89.7 | 88 | 10⁵ |
| steam roasting | | | | |
| (Example) | | | | |

Table 2 shows that the heat treatment apparatus and the method according to the present invention can produce roasted nori which contains less residual phycobilin pigments and has little probability of color reversion and which is of high quality in terms of color tone and taste by virtue of high rates of survival of chlorophyll and umami-provider amino acids, as compared to roasted nori treated by other methods.

[Roasted Nori Quality Evaluation 2]

The degree of crispness, and the green color tone and taste of roasted non were evaluated by sensory testing by 5 panelists. Further, color reversion was tested in such a manner that each of roasted nori obtained under respective conditions was cut to a ¼ size, a two-fold amount of 0.04% acetic acid was applied to one sheet, the sheet was attached to a white board and was allowed to stand as such for 3 hours, and the degree of color reversion was visually determined.

The results are described in Table 3. Here, the color reversion is less and the nori is of higher quality with decreasing number of “+”. The crispness, color tone and taste are more favorable with increasing number of “+”, and are of normal quality when rated as “±” and of improper quality for roasted nori when rated as “−”.

TABLE 3

| | Color | | Color | |
|---|---|---|---|---|
| Roasting methods | reversion | Crispness | tone | Taste |
| Far infrared roasting | +++ | ++ | +++ | ++ |
| Hot air roasting | ++ | + | ++ | + |
| Superheated steam roasting | ++++ | − | − | − |
| (with a roasting machine | | | | |
| for simple drying) | | | | |
| Superheated steam roasting | + | +++ | +++ | +++ |
| (Example) | | | | |

From the foregoing, the comparison of characteristics by roasting systems shows the superiority of the roasting conditions according to the present invention over other roasting systems.

### REFERENCE SIGNS LIST

1 HEAT TREATMENT APPARATUS
10 NORI PLACEMENT SECTION
12 UPLIFT PREVENTING SECTION
20 SUPERHEATED STEAM GENERATOR
22 SUPERHEATED STEAM TRANSFER PIPE
24 SUPERHEATED STEAM JET ORIFICE
26 SUPERHEATED STEAM
50 SHEETED NORI

1.-11. (canceled)

12. A method for producing roasted nori comprising a heat sterilization treatment step of treating a sheeted nori with superheated steam of 150 to 500° C. for 1 second or more,
wherein the sheeted nori is placed on a nori placement section in the heat sterilization treatment step, and
an uplift preventing section including a mesh or a plurality of parallel filamentary belts is placed in the vicinity of the upper face of the sheeted nori so that the heat sterilization treatment step is uniformly carried out so as not to separate the sheeted nori from the nori placement section.

13. The method for producing roasted nori according to claim 12, further comprising a preliminary heating step of heating nori in a form of sheet at a temperature of not less than 50° C., which is carried out prior to the heat sterilization treatment step.

14. The method according to claim 12, wherein the time of the heat sterilization treatment with the superheated steam is between 1 second and 90 seconds.

15. The method according to claim 12, wherein the count of viable bacteria present in the nori after the step of heat sterilization treating the sheeted nori with the superheated steam is not more than 10⁵ per 1 g.

16. A treatment apparatus for heat sterilization treating a sheeted nori, comprising:
a nori placement section having an upper face to place nori thereon and a lower face opposite to the upper face,
an uplift preventing section arranged in the vicinity of a sheeted nori so that a lower face thereof is opposed to the upper face of the nori placement section,
a superheated steam jet orifice through which superheated steam is sprayed to the nori placed on the nori placement section, and
the uplift preventing section is a mesh or a plurality of parallel filamentary belts.

17. The treatment apparatus according to claim 16, wherein the superheated steam jet orifice is arranged so as to be capable of spraying the superheated steam to an upper face of the uplift preventing section, and the uplift preventing section is configured to allow the superheated steam to pass therethrough from the upper face to the lower face thereof.

18. The treatment apparatus according to claim 16, wherein the superheated steam jet orifice is arranged so as to be capable of spraying the superheated steam to the lower face of the nori placement section, and the nori placement section is configured to allow the superheated steam to pass therethrough from the lower face to the upper face thereof.

19. The treatment apparatus according to claim 16, wherein the nori placement section is a belt conveyer including a mesh belt or a plurality of parallel filamentary belts.

20. The treatment apparatus according to claim 19, wherein the uplift preventing section is a belt conveyer.

21. The treatment apparatus according to any one of claims 16 to 20, further comprising a device that performs preliminary heating of nori.
